(19) United States
(12) Patent Application Publication
(10) Pub. No.: US 2008/0201208 A1
(43) Pub. Date: Aug. 21, 2008

(54) Advertising system and method

(76) Inventors: Thomas Hiramatsu Tie, Concord, CA (US); Majid L. Riaziat, San Jose, CA (US); Hugh Norman Chapman, Taylors, SC (US)

Correspondence Address: LAW OFFICE OF DALE B. HALLING, LLC, 655 SOUTHPOINTE CT, SUITE 100, COLORADO SPRINGS, CO, 80906, US

(21) Appl. No.: 12/069,999

(22) Filed: Feb. 14, 2008

Related U.S. Application Data
(60) Provisional application No. 60/889,901, filed on Feb. 14, 2007.

(51) Int. Cl. G09F 15/00

(52) U.S. Cl. 705/10; 705/14

(57) ABSTRACT

An advertising system has a public electronic sign and an audience feedback tracking system that tracks the audience reaction to an advertisement on the electronic sign. The feedback system can include a camera and software that can count the number of people in the audience or provide other data. The feedback system may include an audio feedback system. The system also may include a factor dependent advertising content scheduler that plays an advertisement based on an external factor such as the weather. The display may be cylindrical and may have a number of images displayed simultaneously. Any audio associated with these images may be spatially coordinated with the display images. The display may include a telemetry system that monitors the status of the display.

### RELATED APPLICATIONS

The present invention claims priority on provisional patent application, Serial No. 60/889,901, filed on Feb. 14, 2007, entitled “Display” and is hereby incorporated by reference.

### STATEMENT REGARDING FEDERALLY SPONSORED RESEARCH

Not Applicable

### BACKGROUND OF THE INVENTION

Outdoor and public advertising displays such as billboards are usually sold based on the number of people who pass by the display. The advertiser has no idea whether any of these people actually view the display, how long they view the display or whether their advertisement is effective.

Thus there exists a need for an improved advertising display system that provides more effective feedback to the advertiser.

### BRIEF SUMMARY OF INVENTION

An advertising system that overcomes these and other problems has a public electronic sign and an audience feedback tracking system tracking the audience reaction to an advertisement on the electronic sign. The feedback system can include a camera and software that can count the number of people in the audience or provide other data. The feedback system may include an audio feedback system. The feedback system may include sensors that detect weather or other environmental conditions, or may detect audience actions or responses such as via a touch screen. The system also may include a factor dependent advertising content scheduler that plays an advertisement based on an external factor such as the weather. The display may be cylindrical and may have a number of images displayed simultaneously. Any audio associated with these images may be spatially coordinated with the display images. The display may include a telemetry system that monitors the status of the display.

### BRIEF DESCRIPTION OF THE SEVERAL VIEWS OF THE DRAWINGS

FIG. 1 is a schematic diagram of an advertising display in accordance with one embodiment of the invention;

FIG. 2 is a cross sectional view of the advertising display of FIG. 1 in accordance with one embodiment of the invention;

FIG. 3 is a perspective view of a number of advertising displays in accordance with one embodiment of the invention;

FIG. 4 is a side view of an advertising display showing a number of viewing areas in accordance with one embodiment of the invention;

FIG. 5 is a block diagram of an advertising system in accordance with one embodiment of the invention; and

FIG. 6 is a block diagram of an advertising system in accordance with one embodiment of the invention.

### DETAILED DESCRIPTION OF THE INVENTION

The invention is direct to an advertising system that has a public electronic sign and an audience feedback tracking system that tracks the audience reaction to an advertisement on the electronic sign. The feedback system can include a camera and software that can count the number of people in the audience or provide other data. The feedback system may include an audio feedback system. The feedback system may include sensors that detect weather or other environmental conditions, or may detect audience actions or responses such as via a touch screen. The system may also include a factor dependent advertising content scheduler that plays an advertisement based on an external factor such as the weather. The display may be cylindrical and have a number of images displayed simultaneously. Any audio associated with these images may be spatially coordinated with the display images. The display may include a telemetry system that monitors the status of the display. Note that a public sign in the context of this patent is a sign that displays information, such as advertisements for public consumption in a public place, such as a billboard or handbill sign.

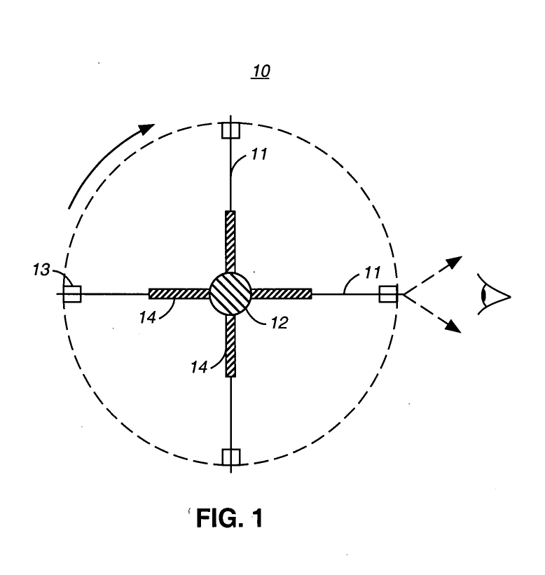

FIG. 1 is a schematic diagram of an advertising display 10 in accordance with one embodiment of the invention. The cylindrical rotating display includes arrays of optical conduits, which in this embodiment are optical fibers 11. The free ends of the optical fibers 11 point outward and are fed by one or more respective control boards 14 mounted on a rotating shaft 12 as part of a rotating assembly. Adjustable supports 13 keep the optical fiber free ends firmly in place. The control board 14 includes the circuitry that delivers electrical power to each light source and controls its intensity as a function of time as required for image formation. One or more image or video signals are transmitted to the control boards, and a lighting sequence is emitted from the LED clusters, that in turn is mixed and delivered by the optical conduits, resulting in the display of an image with each image pixel corresponding to the light output of an optical conduit at a particular position of rotation. Light refers generally to electromagnetic energy in the visible spectrum, but in some embodiments light sources radiate outside the visible spectrum, such as in the infrared and ultraviolet.

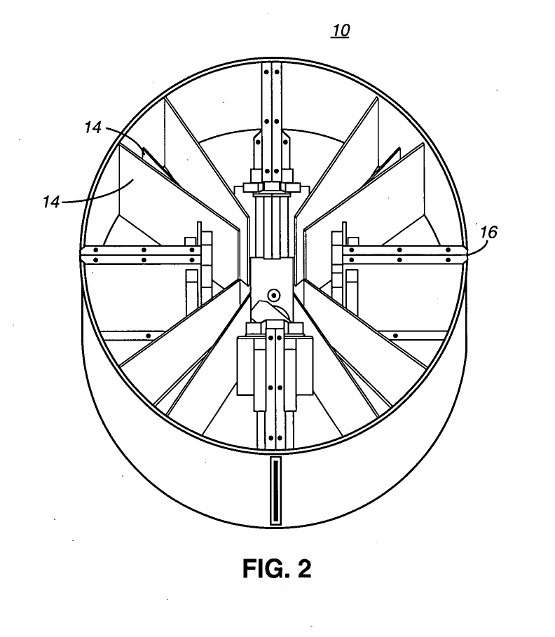

The control board in this embodiment is a PCB, on which are mounted LEDs that produce the lighting necessary for imagery. The LED PCB has multiple clusters of RGB (red green blue), WRGB (white red green blue), or any combination of LED types, depending on the desired effect of the display. Each cluster of LEDs provides the light for a single optical conduit or a single pixel at any given instance. The cluster is physically arranged for efficient coupling to the optical conduit. Another embodiment separates control circuitry and the LEDs into different boards. FIG. 2 is a cross sectional view of the advertising display 10 of FIG. 1 in accordance with one embodiment of the invention.

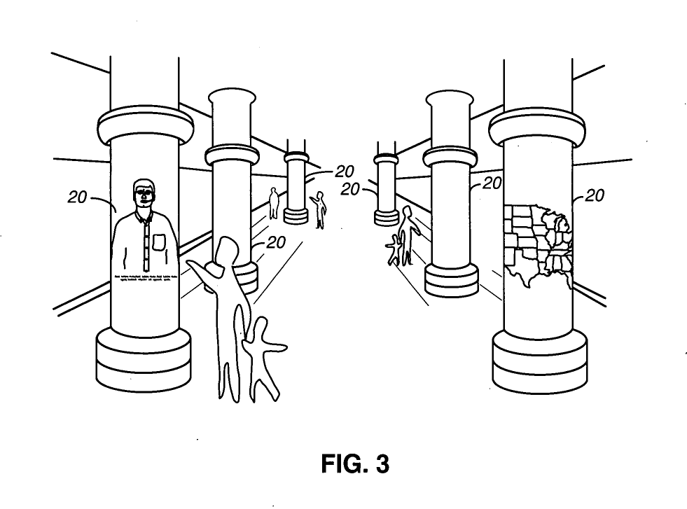

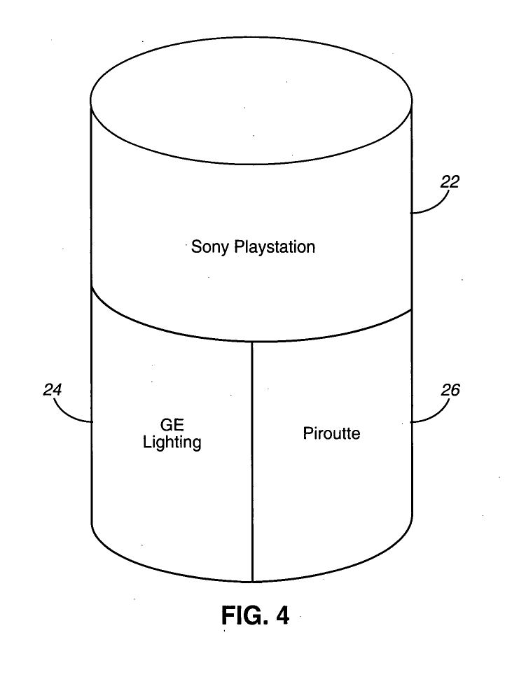

FIG. 3 is a perspective view of a number of advertising displays 20 in accordance with one embodiment of the invention. The displays 20 are public signs that may be indoors or outside. FIG. 4 is a side view of an advertising display 20 showing a number of viewing areas in accordance with one embodiment of the invention. Each viewing area 22, 24 & 26 can have a totally different display. In one embodiment, the display 20 may have up to nine different high definition viewing areas. The viewing areas may be subdivided further or they may be merged to create continuous or seamless larger images. The images may be still images, slide shows, limited action video, repeating video clips or continuous/network video feeds. Both the still and video clips can either stay in one location on the sign or swap locations periodically or slowly revolve. Besides showing advertisements, one of the viewing areas, or dark space (borders) in between viewing areas, may be used to display date, time, and weather information. In addition, viewing areas or dark areas may display billboard space ordering information, stock quotes, news crawlers, or public service announcements, such as Amber alerts or missing person pictures. One or more viewing or dark areas may be interactive allowing a viewer to request directions, request specific advertisements or other information.

In addition, the display may have the ability to display image modification advertisements. Using the camera, the sign can use an image of a member of the audience and reflect that image or show the person wearing a different outfit, hairstyle, in a vacation spot, in a automobile, etc. This can be a very effective personalized advertisement for clothing stores etc.

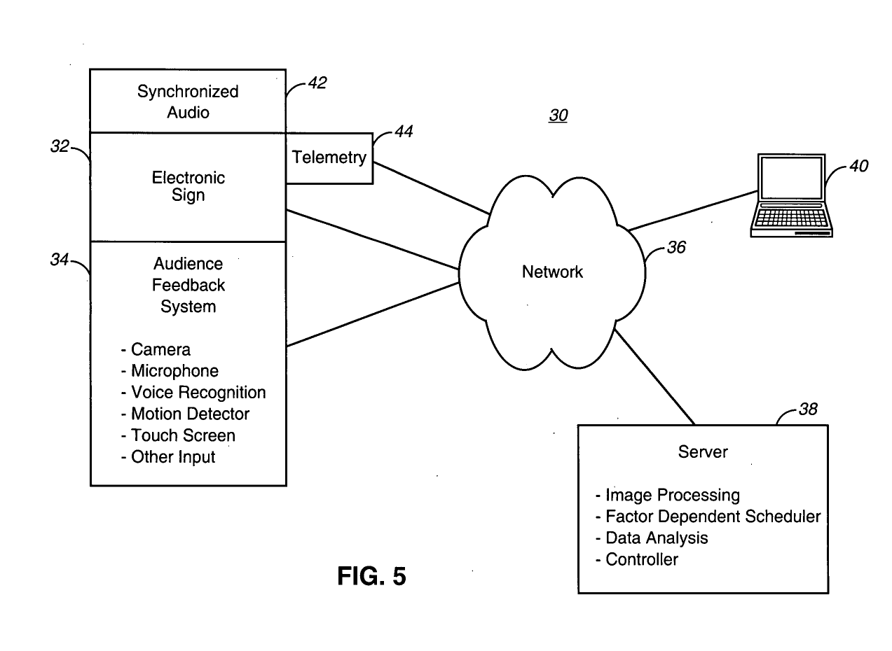

FIG. 5 is a block diagram of an advertising system 30 in accordance with one embodiment of the invention. The system 30 has an electronic sign 32. The electronic sign may be similar to the electronic displays shown in FIGS. 1-4 or may be any other electronic sign. The electronic display 32 has an audience feedback system 34. The electronic sign 32 and audience feedback system 34 are connected through a network 36 to a server 38. Some portion of the functions shown at the server end of the network may optionally be located at the display end of the network. The network 36 may be the Internet, a non-public LAN or WAN (Local or Wide Area Network) or a combination thereof. A user 40, in one embodiment, will be able to log into the server 38 either directly or through the network 36.

The audience feedback system 34 may contain a camera. The camera is used to observe the audience viewing an advertisement. The camera can be mounted in the rotating electronic sign, see FIG. 1, or can be on a stationary part of the sign. The camera and its associated image processing software can count the number of people near the display 32 and time stamp the data. The image processing software may be located at the server 38 or at the audience feedback system 34. The image processing system may also estimate gender, age and other demographic information. The audience feedback system 34 can include a microphone to provide audio feedback. In one embodiment, the feedback system includes voice recognition. This allows for surveys and interactive content selection. The feedback system 34, in one embodiment, includes a touch screen or other input mechanisms to allow for surveys and interactive content selection.

Since the electronic sign can have multiple messages or video clips, a synchronized audio system 42 may be attached to the electronic sign 32. This is achieved by having multiple fixed speakers. Alternatively, this is achieved by having the speakers attached to the rotating drum, see FIG. 1. Note that since the image areas may revolve around the cylindrical sign, the audio has to follow the image area.

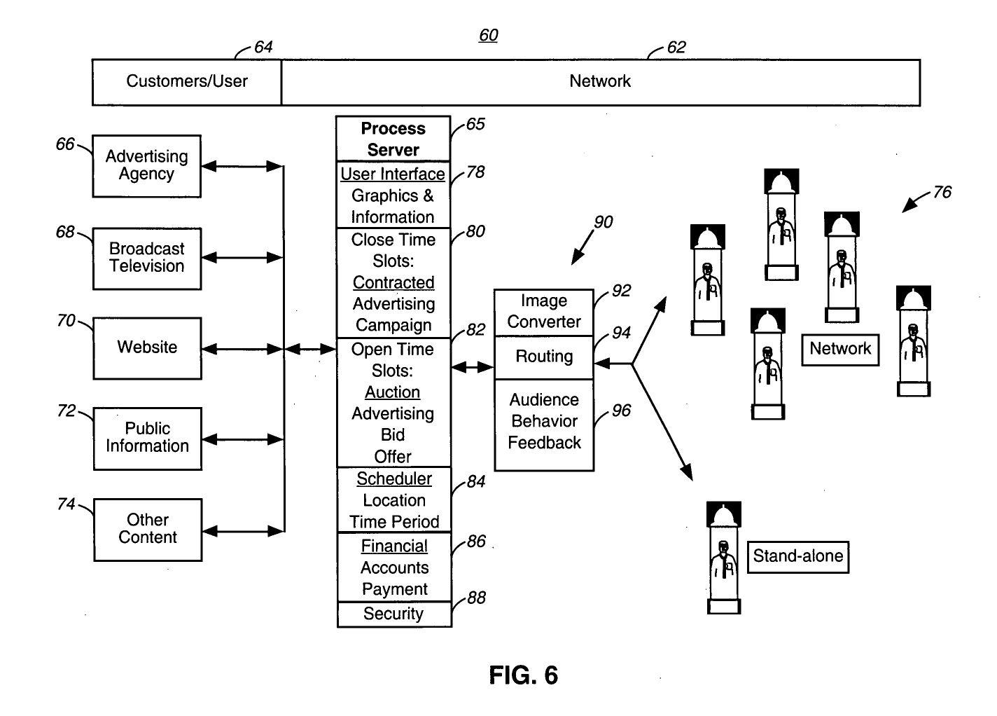

The server 38 has an image processing system as mentioned above. Note that part or all of the image processing system may be located at the sign. In addition, the server 38 has a factor dependent scheduler, part or all of which may also be located at the sign. The factor dependent scheduler allows the electronic sign, in one embodiment, to display a specific advertisement when a motion detector in the audience feedback system 34 detects motion near the sign. Another example of the capabilities of the factor dependent scheduler is to play a specific advertisement based on the weather, time of day, date or other external factor. For instance, an advertisement for umbrellas could be activated by rain. In addition, the level of lighting or color/type of borders or background can be changed based on time of day, holidays, lighting, etc. The server 38 also has a data analysis system that can be used to log the feedback, by type, date, location, audience feedback and analyze this information to determine advertisement effectiveness. A controller in the server is used to do general advertisement scheduling and the functions described with respect to FIG. 6.

In one embodiment, a customer 40 who is or wants to advertise on the electronic sign 32 can connect to the server 38 to buy advertising space, to upload advertising material and other functions. In one embodiment, a person may be able to view the output of the camera at the sign from their computer. This allows a person who is visiting London, for instance, to tell their friends or family to view them online. Other audience-to-audience or audience-to-content portal connections are possible due to the display-camera-microphone-speaker combination, between the electronic sign and any combination of other electronic signs, internet connected computer users or internet based information. These portal possibilities can provide additional attractions to the audience to view the advertisements.

A telemetry system 44 may be associated with the electronic sign 32. The telemetry system can monitor internal and external temperature, the status of pixels, monitor and adjust the output of pixels, monitor maintenance needs or intervals and provide other telemetry data.

FIG. 6 is a block diagram of an advertising system 60 in accordance with one embodiment of the invention. The system 60 has a network 62 that connects customers and users 64 to the process server 65. Some of the customers and users 64 who may connect to the process server 64 include an advertising agency 66, broadcast television 68, website 70, public information 72 and other content 74. Note that the broadcast television 68 and public information 72 would provide content to the displays 76. The website 70 can provide content or can be a method of ordering advertising time and space.

The process sever 65 has a user interface 78 that can help users create content and order advertising space and time. The process server 65 also coordinates closed time slots 80, which are already filled or have a long term lease and open time slots 82, which may be auctioned or otherwise sold. The process server 65 also has a scheduler 84 that tracks and controls which signs display which content and when. A financial system 86 tracks the accounts payment information and a security layer 88 ensures that process server 65 is secure.

Intermediate processes 90 connect the signs 76 with the process server 65. One of the intermediate processes 90 is an image converter 92 that formats the input content to be displayed on the signs 76. A routing process 94 routes the content to the appropriate sign 74. An audience behavior and feedback system 96 is used for tracking the audiences' reaction to various advertisements as explained with respect to FIG. 5. Note that the signs 76 may be networked or stand-alone.

Thus there has been described an improved advertising display system that provides more effective feedback to the advertiser. Note that while the invention has been described with respect to a specific display, the invention may be used with any electronic information sign.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An advertising system, comprising:
a public electronic sign displaying an advertisement; and
an audience feedback tracking system monitoring an audience associated with the advertisement.

2. The system of claim 1, wherein the public electronic sign is cylindrical.

3. The system of claim 1, wherein the audience feedback tracking system includes a camera connected to the public electronic sign.

4. The system of claim 3, further including a server coupled to the camera.

5. The system of claim 4, further including an image processing system coupled to the camera to count a number of viewers of an advertisement.

6. The system of claim 1, wherein the audience feedback tracking system includes an audio feedback system.

7. The system of claim 1, wherein the audience feedback tracking system includes a motion detector.

8. The system of claim 1, further including a factor dependent advertising content scheduler.

9. The system of claim 1, further including a telemetry module monitoring the public electronic sign.

10. A method of operating an advertising system, comprising;
a) displaying an advertisement on a public electronic sign; and
b) tracking an audience feedback of the advertisement.

11. The method of claim 10, wherein step (a) further includes the steps of:
a1) determining if an external factor has occurred;
a2) when the external factor has occurred, selecting a factor dependent advertisement;
a3) displaying the factor dependent advertisement on the public electronic sign.

12. The method of claim 11, wherein the step of determining if the external factor has occurred includes the step of determining if motion has occurred near the public electronic sign.

13. The method of claim 11, wherein the step of determining if the external factor has occurred includes the step of determining if a weather event has occurred near the public electronic sign.

14. The method of claim 11, wherein the step of determining if the external factor has occurred includes the step of determining if a time trigger has occurred.

15. The method of claim 10, wherein step (b) further includes the step of:
b1) imaging an audience near the public display.

16. The method of claim 15, further including the steps of:
b2) determining a key statistic about the audience.

17. The method of claim 10, wherein step (b) further includes the step of:
b1) detecting an audience input.

18. The method of claim 17 wherein the step of detecting an audience input includes performing a voice recognition.

19. The method of claim 17 wherein the step of detecting an audience input includes receiving a touch screen input.

20. The method of claim 10, further including the step of:
c) determining a plurality of audience statistics.

21. An advertising system, comprising:
a cylindrical display;
a plurality of image areas located on the cylindrical display; and
a factor dependent advertising content scheduler.

22. The system of claim 21, further including a sound system playing a plurality of audio tracks.

23. The system of claim 22, wherein the plurality of image areas are coordinated with the plurality of audio tracks.

24. The system of claim 21, further including an audience feedback tracking system.

25. The system of claim 21, further including a telemetry subsystem monitoring the cylindrical display.

26. The system of claim 21, wherein the cylindrical display has an image modification advertising feature.

27. The system of claim 1, wherein the public electronic sign has an image modification advertising feature.

28. The method of claim 10, wherein the advertisement is an image modification advertisement.
